(19) United States
(12) Patent Application Publication
(10) Pub. No.: US 2002/0120625 A1
(43) Pub. Date: Aug. 29, 2002

(54) Computerized system and method for representing and recording multidimensional judgments

(76) Inventors: John Charlton Baird, Newport, NH (US); Marek Cezary Chawarski, New Haven, CT (US)

Correspondence Address: DEVINE, MILLIMET & BRANCH, P.A., 111 AMHERST STREET, BOX 719, MANCHESTER, NH, 03105, US

(21) Appl. No.: 09/950,126

(22) Filed: Sep. 10, 2001

Related U.S. Application Data
(60) Provisional application No. 60/270,854, filed on Feb. 23, 2001.
(60) Provisional application No. 60/292,115, filed on May 18, 2001.

(51) Int. Cl. G06F 7/00

(52) U.S. Cl. 707/10

(57) ABSTRACT

The computerized system and method for representing and recording multidimensional judgments displays multiple judgment representations and receives a user-manipulated adjustment to one or more of the judgment representations. According to a system and method for representing and recording independent multidimensional judgments, multiple adjustable graphical judgment representations (e.g., bars) are displayed simultaneously and adjusted independently of one another. According to a system and method for representing and recording constrained multidimensional judgments, one or more of the other judgment representations are dynamically adjusted when the user makes an adjustment, for example, according to a fixed resource technique. Each user adjustment can be recorded to allow the judgment decisions to be evaluated.

### CROSS REFERENCE TO RELATED APPLICATIONS

The present application claims the benefit of U.S. Provisional Application Serial No. 60/270,854, filed Feb. 23, 2001, and U.S. Provisional Application Serial No. 60/292,115, filed May 18, 2001, both of which are fully incorporated herein by reference.

### TECHNICAL FIELD

The present invention relates to methods for representing and recording personal judgments and more particularly, relates to a computerized system and method for representing and recording multidimensional judgments.

### BACKGROUND INFORMATION

Studies have been performed using fixed resource methods to assess a person's multidimensional judgments or conceptions of complex stimuli whose components are interdependent. These studies and methods are described in various publications¹, all ¹ Baird, J. C., Graf, V., & Degerman, R. People planning by a fixed resource method. Perceptual and Motor Skill, 1972, 34, 799-806. of which are incorporated herein by reference. One problem with the fixed resource methods described in these applications is that the user cannot observe dynamically how a change in one judgment affects a change in other judgments. These methods of assessing a person's multidimensional judgments also did not allow the user to view judgments in context with other judgments simultaneously. These methods also did not provide a way to assess each of the user's judgment decisions.

Accordingly, a computerized system and method is needed that represents multidimensional judgments in a manner such that multidimensional judgments are dynamically changed in response to the user adjusting one of the judgments. A computerized system and method is also needed that represents multidimensional judgments simultaneously to the user such that the user can continuously change any one of the judgments and observe the judgments in context. A computerized system and method is also needed that allows the user's judgment decisions to be evaluated by continuously recording the changes made in the user's judgment. Miller, H. B., and Baird, John C.. Effects of resource constraints on ideal plans. Perceptual and Motor Skill, 1972, 35, 587-595. Baird, J. C., and Williams, R. A fixed resource method for representing the perception of ideal football players. International Journal of Sport Psychology. 1982, 13:21-30.

### SUMMARY

To address the needs described above, a computerized system and method is provided for representing and recording continuous multidimensional judgments. In general, the computerized method displays multiple judgment representations and receives a user-manipulated adjustment to one or more of the judgment representations.

In accordance with one aspect of the present invention, the computerized method represents and records constrained multidimensional judgments.

In accordance with another aspect of the present invention, the computerized method represents and records independent multidimensional judgments.

In accordance with a further aspect of the present invention, the computerized method represents and continuously records multidimensional judgments.

The computerized system preferably implements the methods defined above using software and a computing device.

### BRIEF DESCRIPTION OF THE DRAWINGS

These and other features and advantages of the present invention will be better understood by reading the following detailed description, taken together with the drawings wherein:

FIGS. 1 and 2 are schematic block diagrams of the computerized system for representing and recording continuous multidimensional judgments, according to different embodiments of the present invention;

FIG. 3 is a flow chart illustrating the method for representing and recording constrained multidimensional judgments, according to one embodiment of the present invention;

FIG. 4 is an illustration of graphical judgment representations, according to one embodiment of the present invention;

FIG. 5 is a flow chart illustrating the method for representing and recording constrained multidimensional judgments, according to another embodiment of the present invention;

FIG. 6 is a flow chart illustrating the method for representing and recording independent multidimensional judgments, according to another embodiment of the present invention;

FIG. 7 is an illustration of graphical judgment representations, according to another embodiment of the present invention;

FIG. 8 is a flow chart illustrating the method for representing and continuously recording multidimensional judgments, according to another embodiment of the present invention;

FIGS. 9-15 are screen shots of a computerized employee commitment survey application, according to a further embodiment of the present invention; and

FIG. 16 is an illustration of graphical judgment representations used in a method for representing and recording constrained multidimensional judgments of HIV/AIDS risk, according to yet another embodiment of the present invention.

### DETAILED DESCRIPTION OF THE PREFERRED EMBODIMENTS

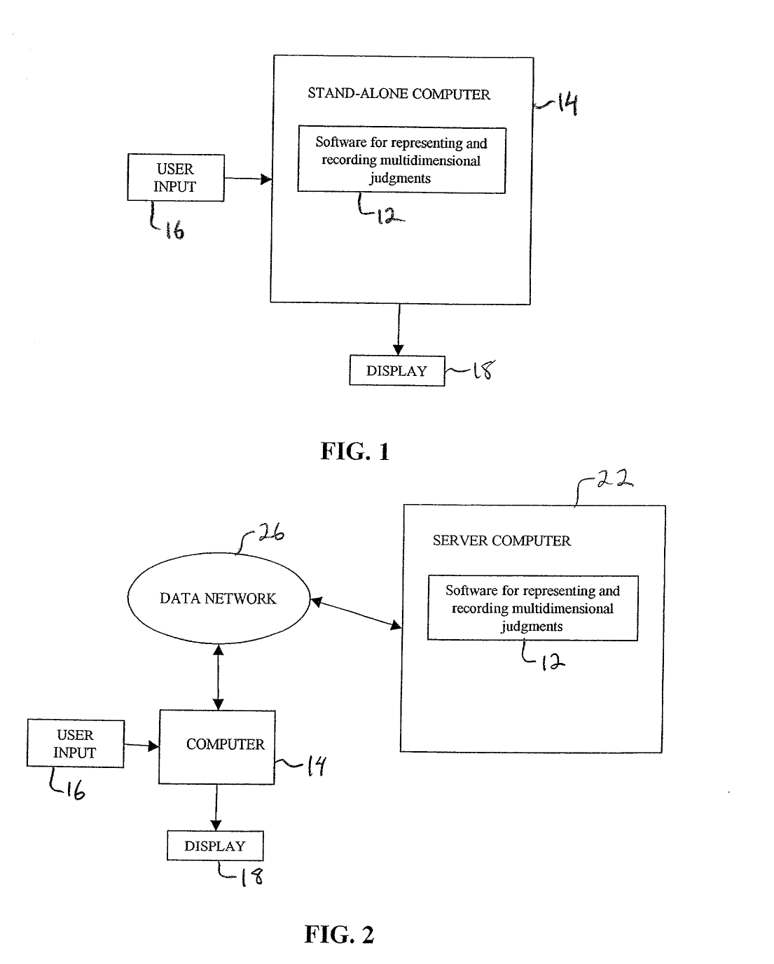

The computerized system for representing and recording multidimensional judgments, as shown in FIGS. 1 and 2, according to the present invention, is preferably implemented using software 12 and a computing device 14 having a user input 16 and a display 18. In one embodiment, the software 12 resides on a stand-alone general purpose computer 14 (FIG. 1), such as a PC, which is used by the user to access the software 12. In another example, the software 12 resides on a server computer 22 (FIG. 2) and is accessed by the user using a computer 14 connected to the server computer 22 over a data network 26, such as the Internet. The display 18 preferably includes a computer screen or any other similar visual display device known to one skilled in the art. The user input 16 preferably includes a mouse, keyboard, or any other input device known to one skilled in the art.

The software 12 can be implemented to perform the methods described below using programming techniques known to a programmer of ordinary skill in the art. For example, the software 12 on the stand-alone computer 14 can be developed using a programming language such as Basic, and the software 12 residing on the server computer 22 can be developed using a programming language such as Java.

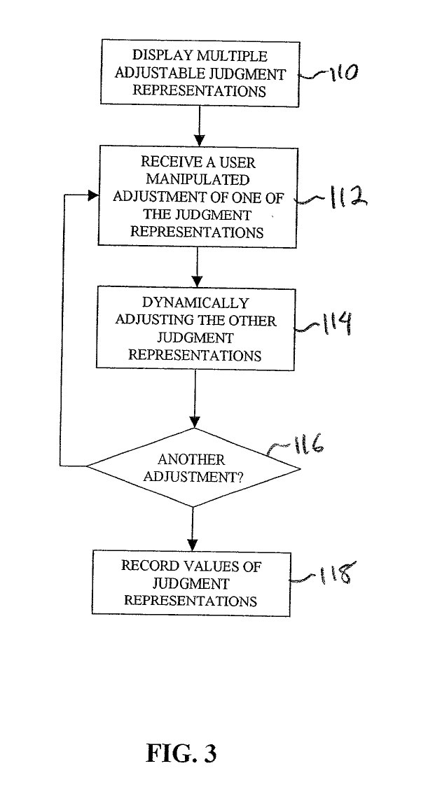

A generic method of representing and recording constrained multidimensional judgments, according to the present invention, is shown in FIG. 3. In general, the system displays multiple adjustable judgment representations to the users, step 110. The judgment representations represent a relative judgment pertaining to certain items, concepts or issues. The system receives a user-manipulated adjustment of one of the judgment representations, step 112. The user-manipulated adjustment allows the users to express and/or modify their judgment pertaining to those items, concepts, or issues. In response to the user's manipulation of one of the judgment representations, the system dynamically adjusts one or more of the other judgment representations based upon the user-manipulated adjustment, step 114, thereby forcing the user to make constrained multidimensional judgments. The user can repeat this process, steps 112 and 114, to adjust any one of the judgment representations multiple times. When the user is satisfied with the judgments represented, step 116, the system records the values of the judgment representations, step 118.

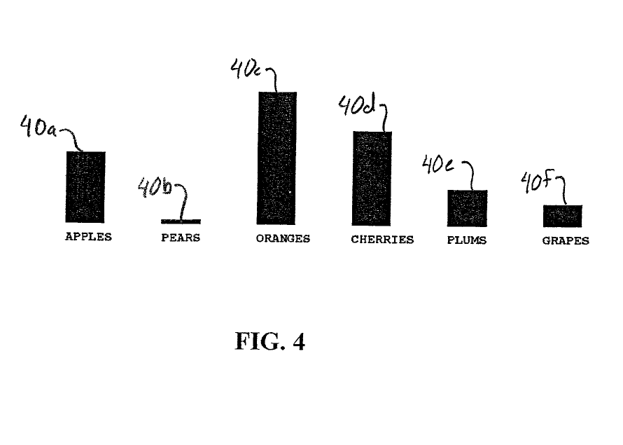

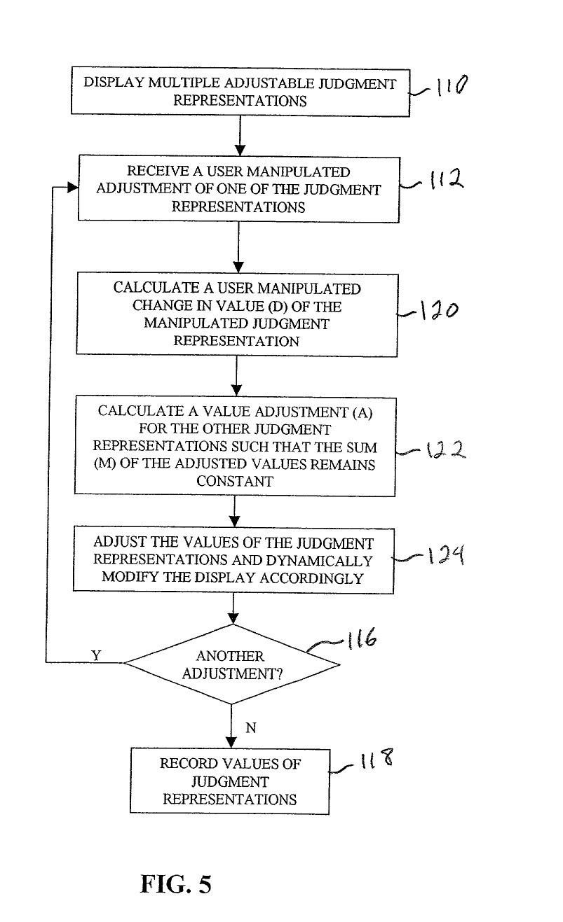

Referring to FIGS. 4 and 5, one embodiment of the method of representing and recording constrained multidimensional judgments is described in greater detail. In one exemplary embodiment, the system displays judgment representations as graphical bars 40a-f, FIG. 4, representing a judgment of the relative importance of an item, such as preferences for different types of fruit. Although the present invention is not limited to a particular number of judgment representations, using more than six items may introduce a response bias. Other forms of graphical judgment representations (such as pie charts) as well as non-graphical judgment representations can also be used. Also, any type of judgment (i.e., not just importance) can be represented by the judgment representations.

The bars 40a-f are preferably equally spaced and oriented either horizontally or vertically and each is preferably identified by an item name. The judgment of the relative importance of items is represented by the heights (or lengths) of the bars 40a-f. In the example shown in FIG. 4, the bar 40c corresponding to oranges is higher or longer than the bar 40d corresponding to cherries, for example, representing a judgment that oranges are more important than cherries.

The user-manipulated adjustments include individual assignments of judgment to each item accomplished by adjusting the height or length of bars 40a-f on the computer screen. Changing a single bar height or length is accomplished by a number of possible methods including, but not limited to, positioning the cursor at the top of the bar and moving the mouse, by positioning the cursor at the top of a bar, clicking, and moving the mouse, or by depressing the up and down arrows on the keyboard. When the arrows are employed, the user shifts between bars by pressing the left and right keys on the keyboard. This causes the name of the item (product or concept) to change color. When a bar changes through movement of the mouse, the user selects the bar to be moved by positioning the cursor at its top edge. Variations in the extent of a bar are preferably continuous and rapid. The software allows the user to manipulate the length of the bars in any order at any time during the procedure.

The judgment representations (e.g., bars) are dynamically and continuously adjusted in response to a user-manipulated adjustment of one of the bars because the bars are dynamically linked. According to one example, adjustable judgment representations (e.g., bars) are each assigned adjustable values (V₁, V₂, . . . Vₙ) wherein the sum (M) of the values (V₁, V₂, . . . Vₙ) is constant. In the exemplary embodiment, the initial state of the display shows all bars at an extent of (1/N)×(M), where N is the number of bars and M is the sum of the values to be distributed among the bars representing alternative items. Changing the height of any one of the bars changes the distribution of values (V₁, V₂, . . . Vₙ) among the remaining bars to maintain the sum of the values (M) as constant, resulting in a change of height in one or more of the remaining bars. For example, if the bar 40a for apples is decreased, the remaining bars 40b-f will increase.

According to another example of the method, the overall maximum or sum (M) can be user-determined and adjusted. For example, an adjustable absolute or overall judgment representation (e.g., a bar) can be included together with the dynamically-linked judgment representations or bars, to allow the user to adjust the maximum or sum (M) to be distributed among the bars. This absolute judgment representation is dynamically linked to the other representations such that the user can go back and forth between absolute (adjusting the maximum) and relative judgments.

In the exemplary method as shown in FIG. 5, the steps for dynamically and continuously adjusting the remaining judgment representations (e.g., bars) include calculating a user manipulated change in value (D) of the manipulated judgment representation, step 120, and calculating a value adjustment (A) for the other judgment representations such that the sum (M) of the adjusted values remains constant, step 122. In one example, the user manipulated change in value (D) is equally distributed among the remaining representations such that the value adjustment (A) is the same for each of the remaining representations (e.g., A=D/N). Where one of the judgment representations cannot be adjusted according to the value adjustment (A), for example, the judgment representation is at or close to a maximum or minimum value, the change in value (D) may be equally distributed over the other remaining judgment representations. Also, the user manipulated change in value (D) can be distributed unequally among one or more of the judgment representations such that the value adjustments (A) are weighted or different for one or more of the judgment representations. The values of the one or more remaining judgment representations are adjusted, step 124, for example, by adding the value adjustment (A) when the manipulated representation is decreased and by subtracting the value adjustment (A) when the manipulated representation is increased.

Thus, any change in a target bar results in a simultaneous change in the other bars in the group such that the sum (M) of bar heights remains constant. When the length of a target bar is changed in the exemplary embodiment, the software automatically adds or subtracts, depending on the direction of change, the same absolute amount (1/N×D), where D is the difference between the target bar's initial value before the change and its value after the change. This results in a change in the opposite direction for each of the other bars so that the sum of all bar heights remains constant. A bar length cannot be extended beyond its preset minimum or maximum extents. If one or more bars are in a state that cannot change in the direction indicated by a change in the extent of the target bar, the amount of change in the length of the target bar is distributed equally among the remaining alternatives.

The user can shift back and forth among the bars until satisfied with the relative allocation of importance or judgment value across the listed products or concepts. From the user's standpoint, the display changes dynamically in response to movement of the mouse or the arrow keys, as if one were viewing multiple thermometers whose levels are moving up and down in response to hand movement.

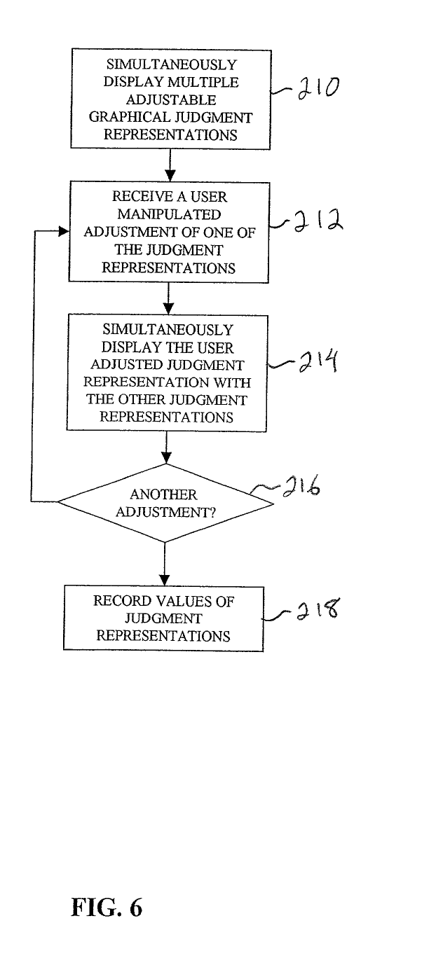

A generic method of representing and recording continuous, independent multidimensional judgments, according to the present invention, is shown in FIG. 6. In general, the system displays multiple adjustable graphical judgment representations simultaneously, step 210. The graphical judgment representations represent a relative judgment pertaining to certain items, concepts or issues. The system receives a user-manipulated adjustment of one of the judgment representations, step 212. The user-manipulated adjustment allows the users to express their judgment pertaining to those items, concepts, or issues. The system displays the user adjusted judgment simultaneously with the other judgments, step 214, allowing the user to visually compare the adjusted judgment in the context of other judgments. According to this method, the judgment representations are not dynamically linked, thereby allowing the user to make independent multidimensional judgments. The user can repeat this process, steps 212 and 214, to adjust any one of the judgment representations multiple times. When the user is satisfied with the judgments represented, step 216, the system records the values of the judgment representations, step 218. In one method, the system also records the values of the judgment representations at each step of the process, for example, by recording every keystroke or user input and the time of the keystroke or input.

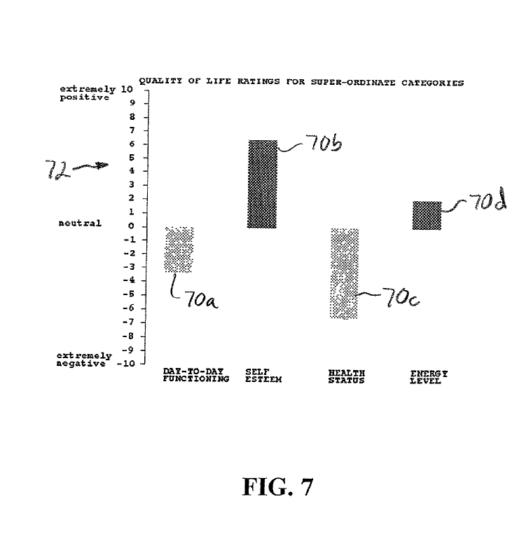

Referring to FIG. 7, one embodiment of the method of representing and recording independent multidimensional judgments is described in greater detail. The visual display presented allows users to express their judgment of the relative importance or judgment value for a set of products or concepts presented together on the screen. According to the exemplary embodiment shown in FIG. 7, the system displays graphical judgment representations as bars 70a-d preferably oriented either horizontally or vertically and each identified by an item name. The user-manipulated adjustments include individual assignments of degree accomplished by adjusting the height or length of bars 70a-d. In this method, changing a bar length is accomplished in the same manner as described above.

In this exemplary embodiment, a vertical (or horizontal) visual analogue scale 72 appears on the left (or top) of the computer screen and two or more bars 70a-70d (number limited by screen size) appear either in a vertical or horizontal orientation adjacent to the scale 72 but displaced from each other and from the scale 72. The user adjusts the length of a target bar to indicate level of positive or negative feelings (e.g., degree of satisfaction or dissatisfaction) for each item associated with a bar. The scale ranges from a specified maximum value (e.g., extremely positive) to a specified minimum value (extremely negative). The present invention is not limited to the positive and negative scale described herein and shown in the exemplary embodiment.

In this example, the initial setting for all bars is zero (center of the visual analogue scale). Positive ratings are indicated by the scale value corresponding to the upper edge of a bar; negative ratings are indicated by the scale value corresponding to the lower edge of the bar. Only one scale value exists at any point in time for each bar, and the opposite end of a bar is always “zero.” Each bar appears in one color (e.g., “green”) when extended to mark values on the scale greater than zero, and in another color (e.g., “red”) for values below zero. The user is permitted to go back and forth between the alternative items and to continue making adjustments until satisfied with the ratings for each.

The innovative aspect of this method is that continuous ratings are given of multiple items presented on the screen at the same time. The usual technique is to allow users to provide single ratings along the scale for single concepts. The advantage of the present method is that the user can go back and forth between concepts and create a profile over the alternatives, which represents a “contextual” judgment of the items rather than a judgment of each item in isolation.

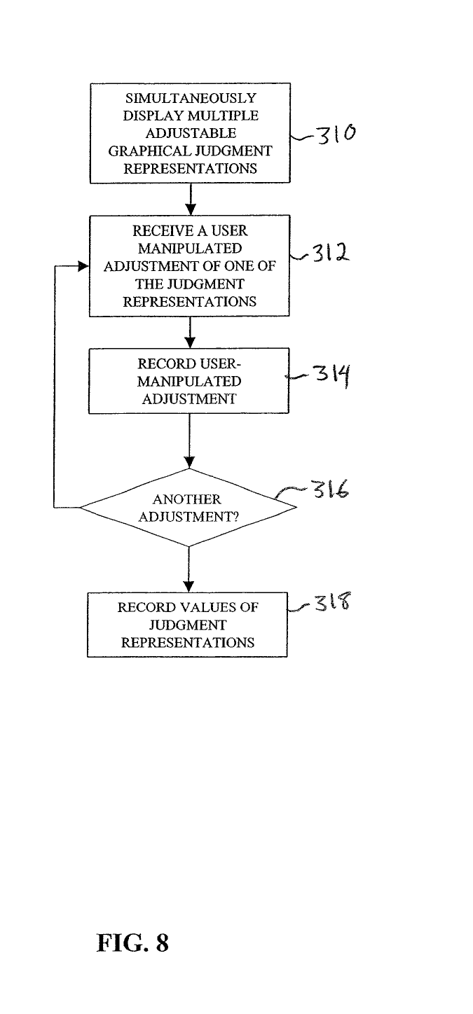

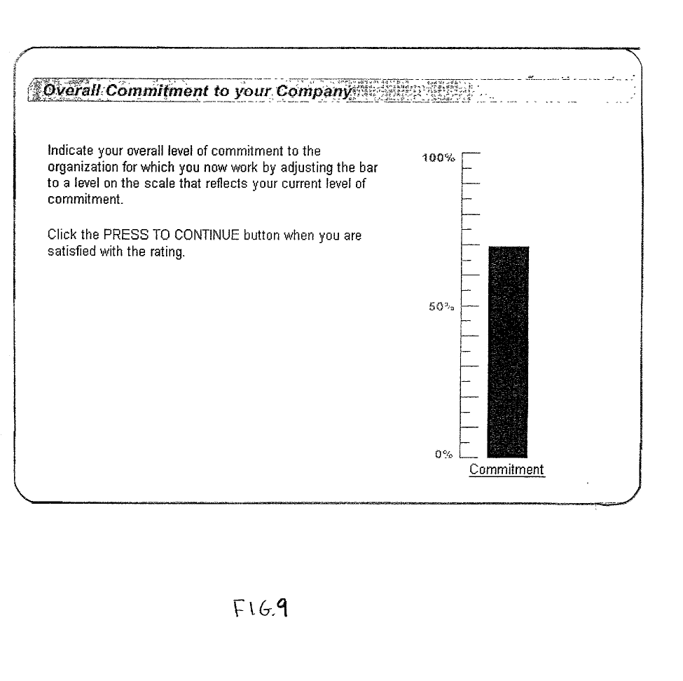

A generic method of representing and continuously recording multidimensional judgments is shown in FIG. 8. In general, the system displays the multiple adjustable judgment representations to the users, step 310. The system receives a user-manipulated adjustment of one of the judgment representations, step 312. The system continuously records every adjustment, step 314, as the user-manipulated adjustments are received. The user can repeat this process, steps 312 and 314, to adjust any one of the judgment representations multiple times. When the user is satisfied with the judgments represented, step 116, the system records the final values of the judgment representations, step 118.

This method of continuously recording multidimensional judgments can be used together with the method where the bars are dynamically linked or with the method where the bars are independent, as described above. This provides information as to the decisions made by the user in making the judgments in addition to the final judgments. For example, keystrokes or user inputs are stored that indicate the order of movement of the bars, the timing of the movements, and the extent of the movements. The recorded adjustments can be replayed graphically (e.g., as a movie) to allow the user's judgment making process to be observed.

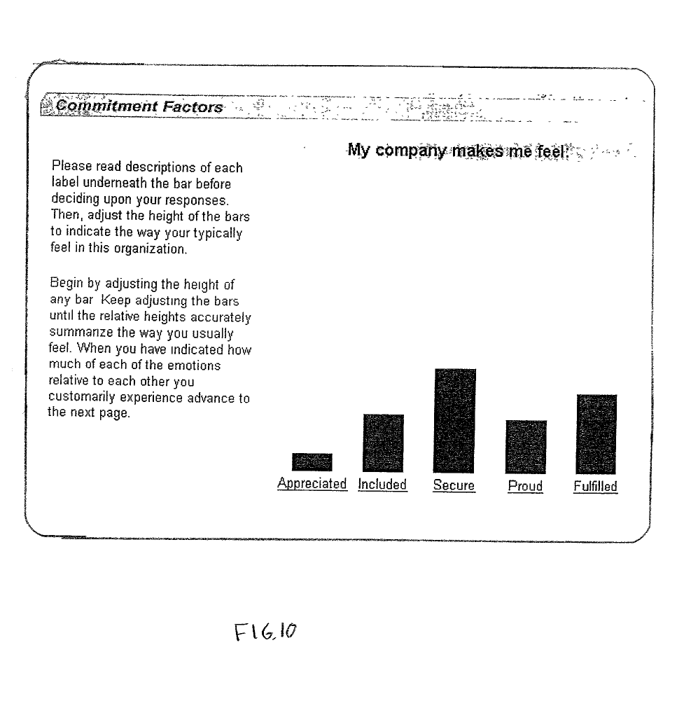

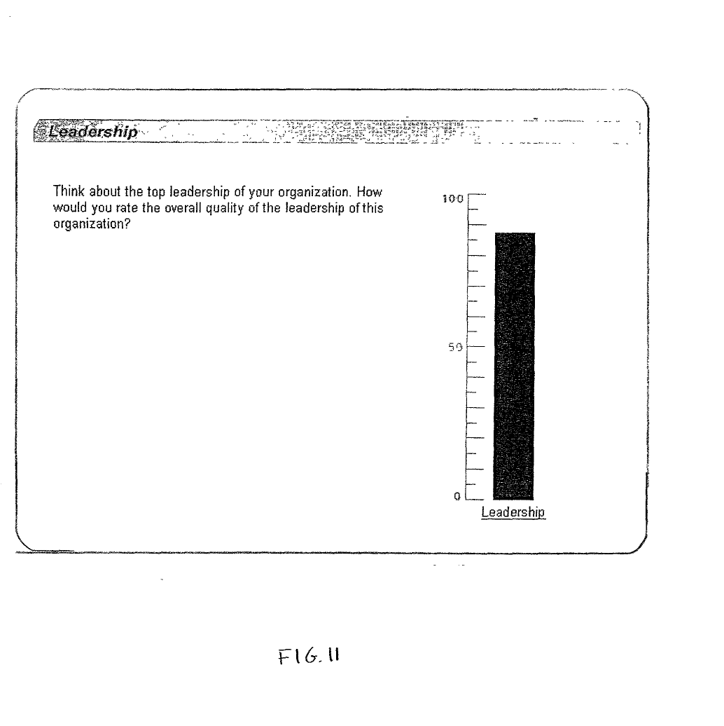

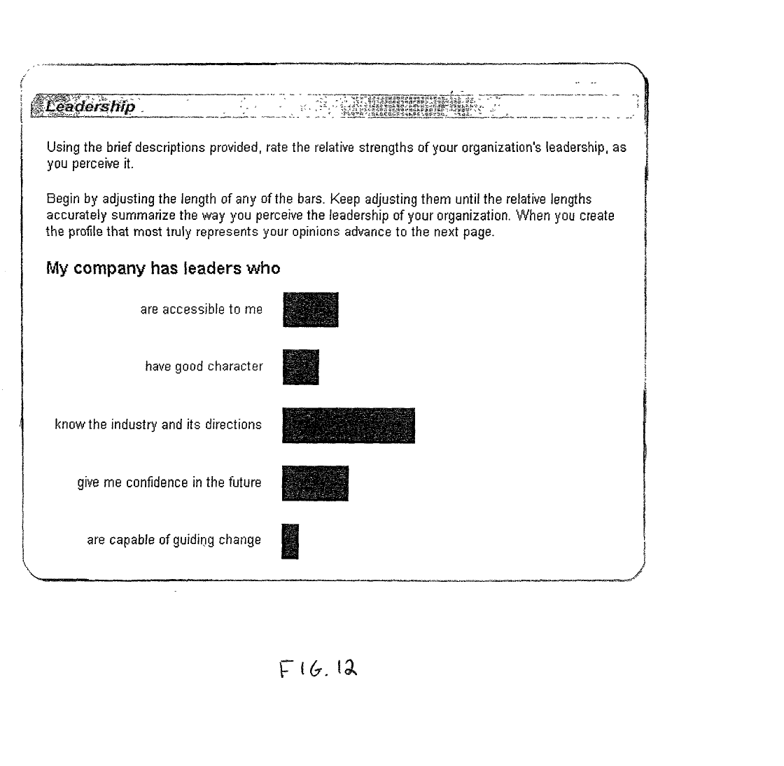

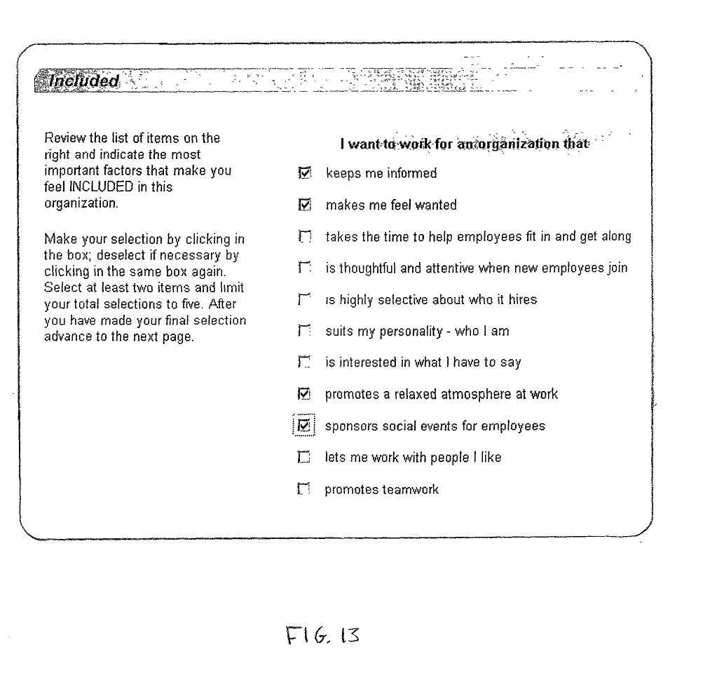

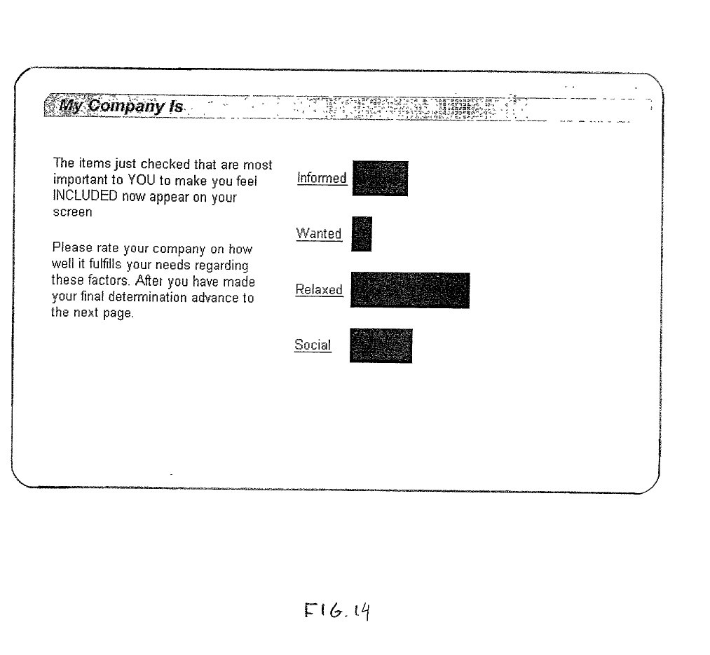

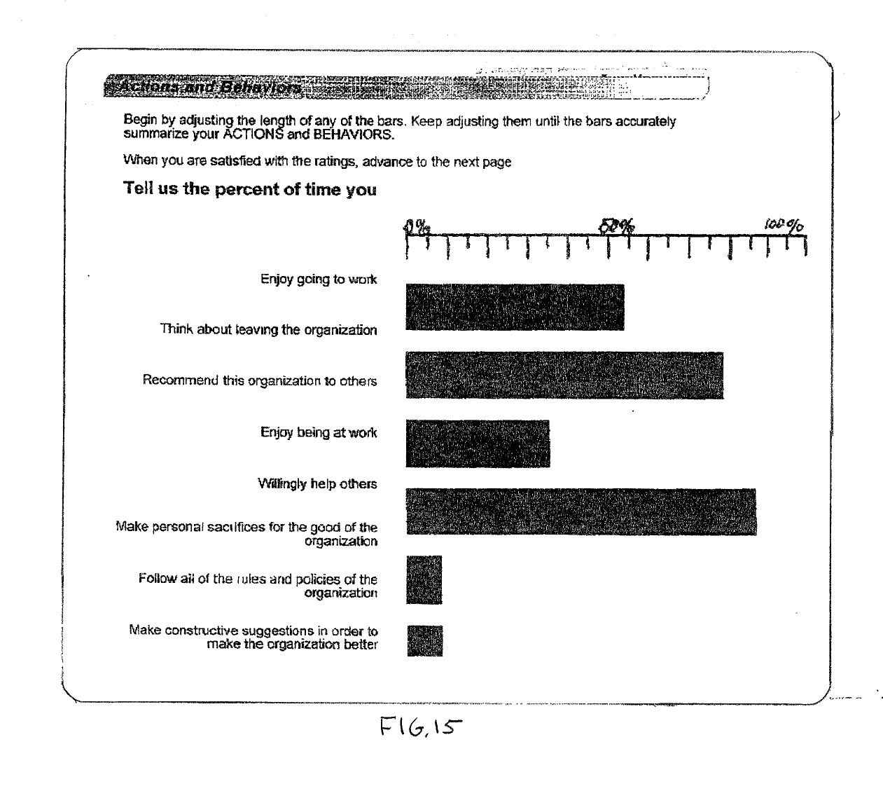

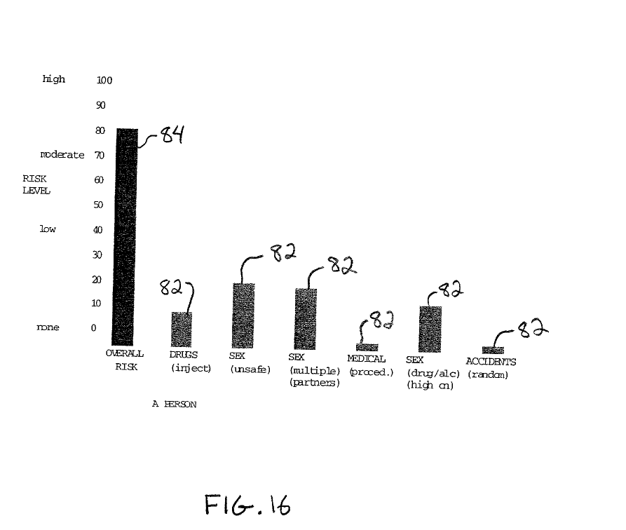

According to one exemplary application, the concepts of the present invention can be used in a computerized survey assessing an employee's commitment to a company. Examples of the screens used in this application are shown in FIGS. 9-15. In this exemplary application, the user is first asked for an overall judgment, such as overall commitment to a company, (FIG. 9). The user is then asked for multidimensional judgments pertaining to various commitment factors (FIG. 10) using the method of representing and recording continuous, constrained multidimensional judgments, according to the present invention. Similarly, the user is asked for an overall judgment as to leadership in the company (FIG. 11) and is asked for constrained multidimensional judgments pertaining to various leadership strengths (FIG. 12). The user may also be asked to provide the relevant factors (FIG. 13) to be used in the multidimensional judgment (FIG. 14). In this exemplary application, the user is also asked to provide contextual simultaneous multidimensional judgments in comparison to a scale (FIG. 15) using the method of representing and recording continuous, independent multidimensional judgments, according to the present invention.

Another exemplary application for the present invention is method of representing and recording constrained multidimensional judgments of HIV/AIDS risk. According to this exemplary application, as shown in FIG. 16, a plurality of adjustable relative judgment representations or bars 82 are displayed together with an overall judgment representation or bar 84. In this particular example, the overall judgment representation or bar represents the user's judgment with respect to the user's judgment of perceived overall risk of contracting HIV/AIDS. The relative judgment representations or bars 82 represent six possible causes of HIV/AIDS. In this example, all of the bars are initially shown at a minimum level. Increasing the height of the overall judgment bar 84 results in a simultaneous increase of the height of each of the relative judgment bars 82, for example, by ⅙ of the height of the overall judgment bar 84. Changing the height of any one of the relative judgment bars 82 does not affect the overall judgment bar 84 but does change the distribution of the overall risk among the possible causes or factors by changing the height of the relative judgment bars 82. This application records the final height of all bars 82, 84 and stores responses in a separate file for later analysis.

Each participant or user was instructed to first represent the overall perceived risk using the overall judgment bar 84 and then to indicate the relative importance of each of the possible causes of risk using the relative judgment bars 82. Any change in one of the relative judgment bars 82 results in a simultaneous change in the other relative judgment bars 82 such that the total allocation of resources (some of the bar heights) always remains equal to the height of the overall judgment bar 84 representing overall risk. The participant or user is permitted to shift back and forth between assessing overall risk using the overall judgment bar 84 and assessing each of the causes using the relative judgment bars 82 until satisfied with the overall risk and with the relative allocation of important across the possible causes. A scale 86 is displayed for measuring the perceived overall risk using the overall judgment bar 84 using numbers and descriptive labels to represent risk levels.

The present invention is not limited to the above applications and can be used in any application in which the user makes multiple judgments.

Modifications and substitutions by one of ordinary skill in the art are considered to be within the scope of the present invention, which is not to be limited except by the following claims.

The invention claimed is:

1. A computerized method of representing and recording constrained multidimensional judgments of a user, said method comprising:
displaying multiple adjustable judgment representations to the user, wherein said judgment representations represent relative judgments of the user;
receiving a user-manipulated adjustment of at least one user manipulated judgment representation selected from said multiple adjustable judgment representations;
dynamically adjusting at least one of said judgment representations, other than said user manipulated judgment representation, based on said user-manipulated adjustment, such that the user can observe dynamically how a change in one judgment affects other judgments; and
recording at least final values of said judgment representations when said user is satisfied with the judgments represented, such that the relative judgments of the user can be evaluated.

2. The method of claim 1 wherein displaying said multiple adjustable judgment representations includes displaying a series of bars, wherein lengths of said bars correspond to said relative judgments.

3. The method of claim 2 wherein said user manipulated adjustment includes a change in length of at least one user manipulated bar selected from said bars.

4. The method of claim 3 wherein said change in length is caused by moving a curser at one end of said at least one of said bars.

5. The method of claim 3 wherein dynamically adjusting at least one of said judgment representations includes automatically changing a length of at least one of said bars other than said user manipulated bar.

6. The method of claim 5 further comprising assigning each of said bars adjustable values corresponding to lengths of said bars, wherein said length of said bars are automatically changed such that a sum of said values remains constant when said length of said user manipulated bar is adjusted by said user.

7. The method of claim 6 wherein a change in said value of said user manipulated bar is substantially equally distributed among remaining ones of said bars such that said sum remains constant.

8. The method of claim 6 further comprising:
displaying an adjustable overall judgment representation, wherein a value of said adjustable overall judgment representation corresponds to said sum;
receiving a user adjustment of said adjustable overall judgment representation; and
automatically adjusting said values of said adjustable judgment representations and the lengths of said bars in response to said user adjustment of said adjustable overall judgment representation.

9. The method of claim 1 wherein each of said adjustable judgment representations is assigned an adjustable value, and wherein a sum of said adjustable values remains substantially constant during adjustments of said adjustable judgment representations.

10. The method of claim 9 further comprising:
displaying an adjustable overall judgment representation, wherein an adjustable value of said adjustable overall judgment representation corresponds to said sum of said adjustable values of said adjustable judgment representations;
receiving a user adjustment of said adjustable overall judgment representation; and
automatically adjusting said values of said adjustable judgment representations in response to said user adjustment of said adjustable overall judgment representation.

11. The method of claim 9 wherein dynamically adjusting said at least one of said judgment representations further comprises:
calculating a user manipulated change in said adjustable value of said user manipulated judgment representation in response to said user adjustment;
calculating a value adjustment for said at least one of said judgment representations other than said user manipulated judgment representation such that the sum of the adjustable values remains constant;
adjusting the adjustable values of said at least one of said judgment representations using said value adjustment; and
displaying adjusted said judgment representations.

12. The method of claim 11 wherein said value adjustment is substantially the same for each of said judgment representations other than said user manipulated judgment representation.

13. The method of claim 11 wherein said value adjustment is different for at least one of said judgment representations.

14. The method of claim 11 wherein said value adjustment is less for at least one of said judgment representation that is near a limit.

15. The method of claim 1 further comprising continuously recording each adjustment of said judgment representations.

16. The method of claim 15 further comprising continuously recording the time of each adjustment of said judgment representations.

17. The method of claim 1 further comprising receiving user selections of said judgment representations to be displayed and adjusted.

18. A computerized method of representing and recording constrained multidimensional judgments of a user, said method comprising:
displaying multiple adjustable judgment representations, wherein each of said judgment representations has an adjustable value, and wherein a sum of said adjustable values is substantially constant;
receiving a user manipulated adjustment of at least one user manipulated judgment representation selected from said judgment representations;
calculating a user manipulated change in value of said user manipulated judgment representation;
calculating a value adjustment for at least one remaining judgment representation such that said sum remains substantially constant;
adjusting said adjustable value of said at least one remaining adjustable judgment representation;
dynamically displaying said judgment representations having said adjustable values such that the user can observe dynamically how a change in one judgment affects other judgments; and
recording at least final values of said adjustable judgment representations such that the judgments of the user can be evaluated.

19. The method of claim 18 wherein said value adjustment is substantially the same for each of said remaining judgment representations.

20. The method of claim 18 wherein said value adjustment is different for at least one of said remaining judgment representations.

21. The method of claim 18 further including recording each adjustment of said judgment representations.

22. The method of claim 18 wherein said judgment representations are graphical representations.

23. The method of claim 18 further comprising receiving a user adjustment of said sum.

24. The method of claim 18 further comprising:
displaying an adjustable overall judgment representation, wherein an adjustable value of said overall judgment representation corresponds to said sum;
receiving a user-manipulated adjustment of said adjustable overall judgment representation resulting in an adjusted sum; and
adjusting said multiple adjustable judgment representations such that the values of said multiple adjustable judgment representations add up to said adjusted sum.

25. A computerized system for representing and recording constrained multidimensional judgments of a user, said system comprising:
means for displaying multiple adjustable judgment representations to the user, wherein said judgment representations represent relative judgments of the user;
means for receiving a user-manipulated adjustment of at least one user manipulated judgment representation selected from said multiple adjustable judgment representations;
means for dynamically adjusting at least one of said judgment representations, other than said user manipulated judgment representation, based on said user-manipulated adjustment, such that the user can observe dynamically how a change in one judgment affects other judgments; and
means for recording at least final values of said judgment representations when said user is satisfied with the judgments represented, such that the relative judgments of the user can be evaluated.

26. A computerized system for representing and recording constrained multidimensional judgments of a user, said system comprising:
means for displaying multiple adjustable judgment representations, wherein each of said judgment representations has an adjustable value, and wherein a sum of said adjustable values is substantially constant;
means for receiving a user manipulated adjustment of at least one user manipulated judgment representation selected from said judgment representations;
means for calculating a user manipulated change in value of said user manipulated judgment representation;
means for calculating a value adjustment for at least one remaining judgment representation such that said sum remains substantially constant;
means for adjusting said adjustable value of said at least one remaining adjustable judgment representation;
means for dynamically displaying said judgment representations having said adjustable values such that the user can observe dynamically how a change in one judgment affects other judgments; and
means for recording at least final values of said adjustable judgment representations such that the judgments of the user can be evaluated.

27. A computer program product, stored on a storage medium, for representing and recording constrained multidimensional judgments of a user, said computer program product comprising:
code for displaying multiple adjustable judgment representations to the user, wherein said judgment representations represent relative judgments of the user;
code for receiving a user-manipulated adjustment of at least one user manipulated judgment representation selected from said multiple adjustable judgment representations;
code for dynamically adjusting at least one of said judgment representations, other than said user manipulated judgment representation, based on said user-manipulated adjustment, such that the user can observe dynamically how a change in one judgment affects other judgments; and
code for recording at least final values of said judgment representations when said user is satisfied with the judgments represented, such that the relative judgments of the user can be evaluated.

28. A method of representing and recording continuous, independent multidimensional judgments, said method comprising:
simultaneously displaying multiple adjustable graphical judgment representations;
receiving a user manipulated adjustment of at least one of said judgment representations;
simultaneously displaying said adjustment representations including said user manipulated adjustment; and
continuously recording each of said user manipulated adjustments and recording a final value of said judgment representations such that the judgments and judgment decisions of the user can be evaluated.

29. The method of claim 28 further comprising:
displaying said graphical judgment representations together with a scale.

30. The method of claim 29 wherein said scale includes positive and negative values, and wherein said graphical judgment representations are adjustable above and below a zero point to represent positive and negative judgments.

31. The method of claim 28 further comprising continuously recording the time of each of said user adjustments.

32. The method of claim 28 wherein continuously recording each of said user adjustments includes continuously recording every user input.

33. A method of conducting a computerized survey, said method comprising:
displaying an inquiry to a user;
displaying multiple adjustable judgment representations, wherein each of said adjustable judgment representations corresponds to a potential response to said inquiry, and wherein said judgment representations represent relative judgments of the user;
receiving a user-manipulated adjustment of at least one user manipulated judgment representation selected from said judgment representations;
dynamically adjusting at least one of said judgment representations, other than said user manipulated judgment representation, based on said user-manipulated adjustment; and
recording at least a final value of said judgment representations when said user is satisfied with the judgments represented, to allow evaluation of the judgments of said user.

34. The method of claim 33 further comprising:
displaying an adjustable overall judgment representation corresponding to said inquiry;
receiving a user manipulated adjustment of said adjustable overall judgment representation; and
recording at least a final value of said overall adjustable judgment representation.

35. The method of claim 33 further comprising:
prior to displaying said multiple adjustable judgment representations, displaying a plurality of potential responses to said inquiry; and
receiving user selections of at least some of said potential responses, wherein said multiple adjustable judgment representations displayed correspond to said potential responses selected by said user.

36. The method of claim 33 wherein each of said adjustable judgment representations is assigned an adjustable value, and wherein a sum of said adjustable values remains substantially constant during adjustments of said adjustable judgment representations.

37. A system for conducting a computerized survey, said system comprising:
means for displaying an inquiry to a user;
means for displaying multiple adjustable judgment representations, wherein each of said adjustable judgment representations corresponds to a potential response to said inquiry, and wherein said judgment representations represent relative judgments of the user;
means for receiving a user-manipulated adjustment of at least one user manipulated judgment representation selected from said judgment representations;
means for dynamically adjusting at least one of said judgment representations, other than said user manipulated judgment representation, based on said user-manipulated adjustment; and
means for recording at least a final value of said judgment representations when said user is satisfied with the judgments represented, to allow evaluation of the judgments of said user.

38. A computer program product, stored on a storage medium, for conducting a computerized survey, said computer program product comprising:
code for displaying an inquiry to a user;
code for displaying multiple adjustable judgment representations, wherein each of said adjustable judgment representations corresponds to a potential response to said inquiry, and wherein said judgment representations represent relative judgments of the user;
code for receiving a user-manipulated adjustment of at least one user manipulated judgment representation selected from said judgment representations;
code for dynamically adjusting at least one of said judgment representations, other than said user manipulated judgment representation, based on said user-manipulated adjustment; and
code for recording at least a final value of said judgment representations when said user is satisfied with the judgments represented, to allow evaluation of the judgments of said user.
